(19) United States
(12) Patent Application Publication
(10) Pub. No.: US 2002/0124250 A1
(43) Pub. Date: Sep. 5, 2002

(54) Hybrid advertising broadcast method

(76) Inventors: Andrew M. Proehl, San Francisco, CA (US); Matthew S. Chang, San Diego, CA (US); Aditya Krishnan, San Diego, CA (US); David K.L. Yang, San Jose, CA (US); Fred J. Zustak, Poway, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/798,838

(22) Filed: Mar. 2, 2001

(51) Int. Cl. H04N 7/173

(52) U.S. Cl. 725/32; 725/110; 725/109

(57) ABSTRACT

A method and structure for distributing hybrid advertisements, audio programming, video programming or other programming types. A set-top box is provided with two communications links, one for receiving conventional television programs including short duration advertisements and one for receiving corresponding extended length advertisements from a service provider. After viewing an abbreviated advertisement, a viewer of the system may indicate a desire to view an extended length advertisement corresponding to the abbreviated advertisement and the system will display the requested extended length advertisement for viewing by the viewer.

### FIELD OF THE INVENTION

This invention relates generally to the distribution of programming, such as audio, video, or audio/visual advertisements, to a viewer using a combination of a broadcast television link (such as terrestrial, cable or satellite) and a bi-directional communication link (such as Digital Subscriber Line).

### BACKGROUND OF THE INVENTION

Television programming is generally a mix of entertainment and information programming and commercials. The various program channels compete with one another to attract viewers. This has tended to increase the cost of programming and, consequently, the cost of television advertising is very high.

The Internet provides an alternative medium for the advertiser to provide information to the consumer; however, the consumer must actively seek out a web site. In contrast, a television commercial can reach a passive consumer, who may have never heard of a particular company or product. Further, the number of web sites greatly exceeds the number of television broadcast channels, so it is difficult to reach a large audience with web site advertising.

The distribution of television programming, and by extension, television advertising, is controlled by a relatively small number of companies and the cost of developing a new channel and advertising is very high. Television advertising, therefore, geared to people having connection to web-sites is a concern. What is needed is an efficient way to promote, through television advertising, connection to websites.

### SUMMARY OF THE INVENTION

According to the present invention, a method and system are provided by which a television viewer can respond to the abbreviated advertisement, broadcast via terrestrial, cable or satellite television, and request the extended length version of the advertisement. The abbreviated advertisement and the extended length advertisement together comprise a hybrid advertisement that may be provided to the viewer by the method and system. The system includes an interactive set-top box, described below. In addition to a standard television link, the set-top box is connected to a service provider via a second communication link, such as a telephone line. This service provider may not be the same as the television program distributor. The request for the advertisement is sent from the viewer's set-top box to the service provider, which responds by transmitting the requested extended length advertisement to the viewer's set-top box. Alternatively, the service provider may download a number of extended length advertisements to the viewer based on marketing data or on the viewer's prior requests. In this scenario, there is minimum or no delay associated with delivery of the extended length advertisement to the viewer. The received extended length advertisement is preferably stored on a medium, such as a hard disk drive, in the set-top box or on a personal video recorder.

The system of the current invention is a benefit to the advertiser, which has a route to deliver extended length advertisements without the high cost of television broadcast time. It is also a benefit to the viewer who can obtain more information on the products or services of interest without having to view extended commercials of other products or services. Finally, it is of benefit to the service provider who can derive television advertising revenue without the expense of developing a television channel.

The above summary description is intended to illustrate exemplary embodiments of the invention, which will be best understood in conjunction with the detailed description to follow, and are not intended to limit the scope of the appended claims.

### BRIEF DESCRIPTION OF THE DRAWINGS

The novel features believed characteristic of the invention are set forth in the claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a block diagram for an exemplary hybrid advertising system.

FIG. 2 shows a system configuration for a digital set-top box, in accordance with the current invention.

FIG. 3 is a flow chart for an exemplary mode of operation of a set-top box of the present invention.

FIG. 4 is a flow chart for an exemplary mode of operation of a media server of the present invention.

### DESCRIPTION OF THE INVENTION

While this invention is susceptible of embodiment in many different forms, there is shown in the drawings and will herein be described in detail specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several Views of the drawings.

The invention provides a mechanism for distributing advertisements, audio programming, video programming, or data, herein generically referred to as programming, in a manner that may be less expensive than current television advertising and yet still reaches a large audience.

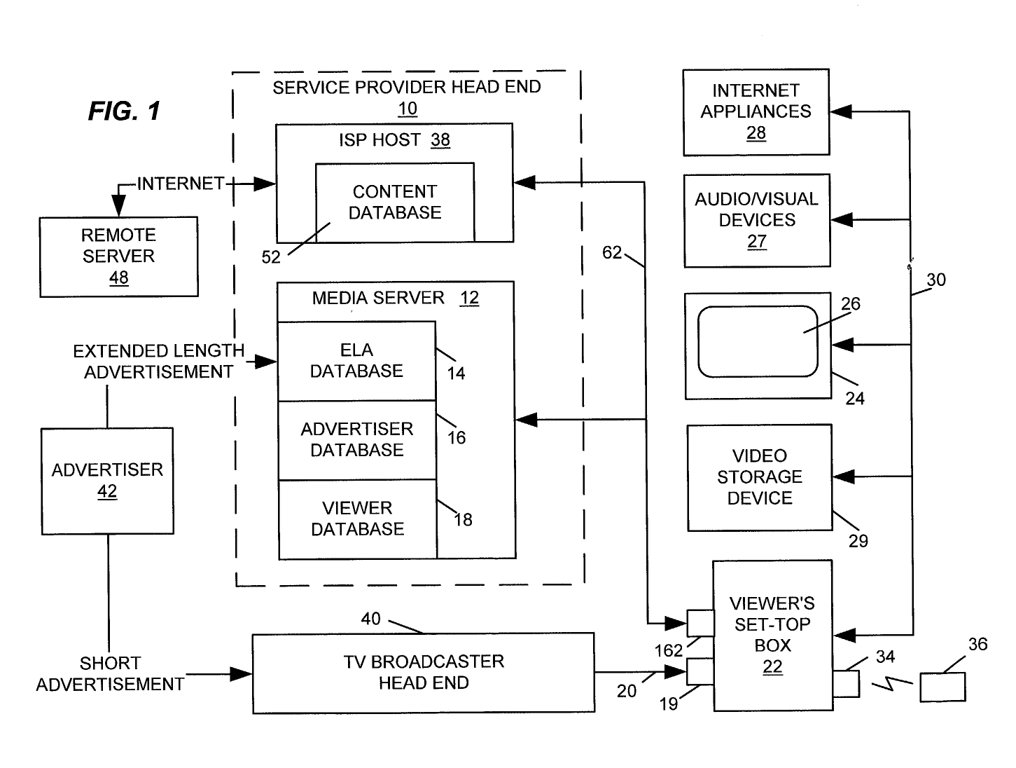

Referring to FIG. 1, a block diagram for an exemplary hybrid advertising system 100 is shown. Advertiser 42 supplies short duration advertisements to television broadcaster 40 and corresponding extended length advertisements to a service provider. The system 100 includes, at a head end of the service provider 10, an extended length advertisement (ELA) database 14 and a media server 12 for distributing the extended length advertisements to television viewers. The media server 12 might also provide additional content such as associated Web pages and other related content. The media sever may also include storage means for advertiser database 16 containing data related to the distribution and viewing of the extended length advertisements, and storage means for viewer database 18 containing data related to the television viewers. Set-top box 22 can generally provide, through television input port 19, for reception of television broadcasts over a transmission medium 20, which may be a cable, satellite, terrestrial broadcast or other link with television broadcaster 40. In addition, set-top box 22 provides for communication over bi-directional communication link 62 through bi-directional communication port 162. This link can be effected, for example, by using asymmetrical communication techniques, using dual communication media—one for the uplink and one for the downlink—or single communication media with time-, frequency-, or code division multiplexing. In any event, the STB 22 can have its own Universal Resource Locator (URL) or IP address or other unique identifier assigned thereto to provide for addressability by the head end and users of the Internet.

The head end of the television broadcaster 40 is operatively coupled by transmission medium 20 to a set-top box (STB) 22, and provides television programming and short-duration advertisements. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The media server 12 is operatively coupled by bi-directional communication link 62 to the port 162 on set-top box (STB) 22. The bi-directional communication link 62 may be provided via a dial-up or DSL connection or any of a variety of known electronic transmission mediums. In contrast to the transmission medium 20, it is not necessary for the link 62 to have sufficient bandwidth to deliver high quality video advertisements in real time.

The exemplary system 100 further includes a TV 24, such as a digital television, having a display 26 for displaying programming, etc. The STB 22 may be coupled to the TV 24 and various other audio/visual devices 27 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. For the current system, at least one video storage device 29 (such as a hard disc drive, video cassette recorder) is required. In one embodiment, interface 30 conforms to an interface standard such as the Institute of Electrical and Electronics Engineers (IEEE) 1394 standard, but could also be wholly or partially supported by a DVI interface (Digital Visual Interface—Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 30. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22. Alternatively, the components of the video storage device 29 and the STB 22 may be combined.

By way of example, the STB 22 may be coupled to devices such as a personal computer, video cassette recorder, camcorder, digital camera, personal digital assistant and other audio/visual or Internet related devices. In addition, a data transport architecture may be utilized to enable interoperability among devices on a network regardless of the manufacturer of the device. This forms a home network system wherein electronic devices and Internet appliances are compatible with each other. The STB 22 runs an operating system suitable for a home network system.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line), to provide access to services and content from the ISP and the Internet. The connection could alternatively be made using the transmission medium 20 (e.g., using a cable modem) or the bi-directional communications link 62, described above. The ISP host 38 provides various content to the user that is obtained from a content database 42. STB 22 may also be used as an Internet access device to obtain information and content from remote servers such as remote server 48 via the Internet using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, November 1999.

However, one feature of the current invention is the creation of hybrid distribution system for advertisements. In addition to the well established distribution method via television broadcast, a second distribution channel—the bi-directional link—is added. This channel need not be controlled by the television distributor, and therefore provides a way for companies other than the television operators to deliver video advertising.

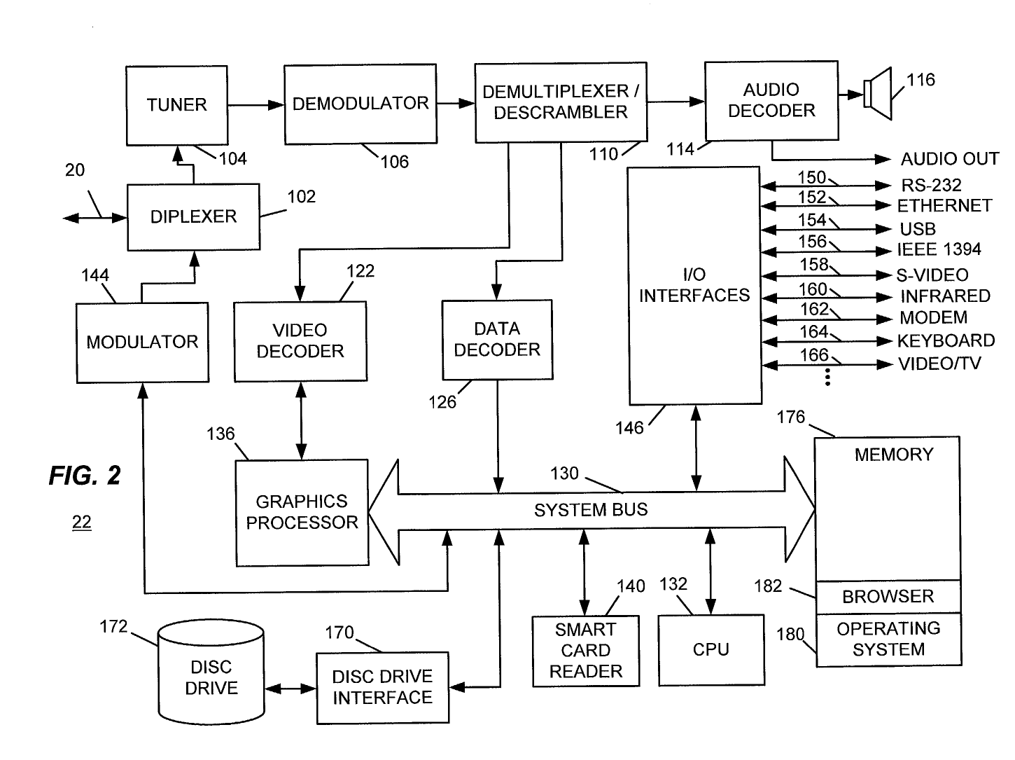

Referring now to FIG. 2, a typical system configuration for a digital set-top box 22 is illustrated. This exemplary set-top box includes a modem 162 (be it dial-up, cable, DSL or other technology modem) to facilitate access to the service provider over bi-directional communications link 62. This modem may also be used for Internet or other data communication functions. In one preferred embodiment, modem 162 is an ADSL (Asymmetrical Digital Subscriber Line) or VDSL (very-high-bit-rate Digital Subscriber Line) modem to facilitate high speed network access, in which case bi-directional link 62 includes a twisted-pair wire connection. Alternatively, the bi-directional link 62 may be provided by an optical cable. Thus, the STB 22 can carry out bi-directional communication with the service provider. Full-length advertisements are downloaded from the service provider, demodulated by modem 162 and passed to the system bus 130. They may then be stored on a video storage device, such as disc drive 172, memory 176 or passed via one of the I/O interfaces 146 to an external video storage device.

In the exemplary set-top box, shown in FIG. 2, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 may be provided as an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bi-directional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio / visual devices 26, gaming devices (not shown), Internet Appliances 28, etc.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY 50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing a list of available extended length advertisements formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

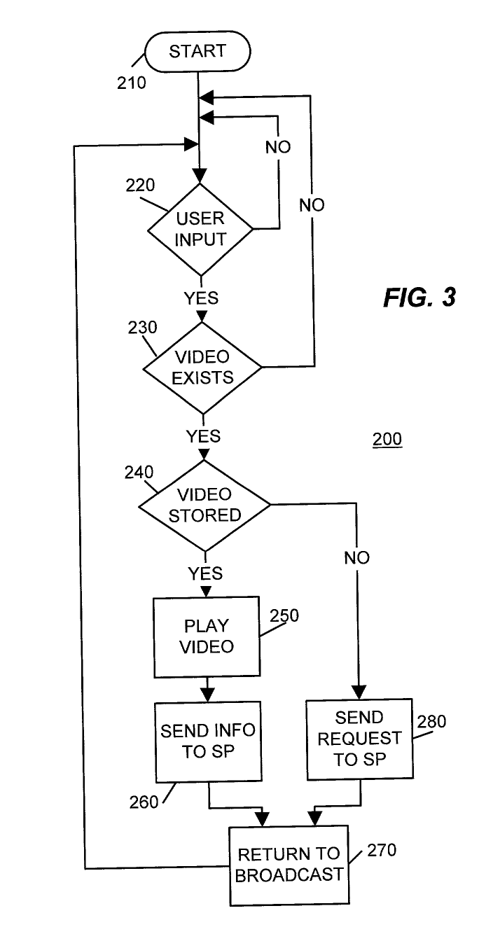

An exemplary mode of operation 200 for the set-top box is shown in FIG. 3. At the start of operation 210, the set-top box acts as a conventional receiver of broadcast television. While there is no input from the viewer (via IR remote control, mouse or other input device) the set-top box continues in normal operation as depicted by the negative branch from decision block 220. The television channel contains a sequence of program time segments and advertisement time segments. Some of the time segments will contain short duration advertisements designed to tempt the viewer into requesting the corresponding extended versions of the advertisements. The viewer (the user) may request an extended advertisement by providing an input to the system. The input may be from an infrared remote control, a computer mouse, a keyboard, a voice command or some other input, and is received by STB 22. The system may continually check (poll) all input devices or the input device may generate an interrupt to inform the system that the input should be processed. Upon receipt of a user input, as depicted by the positive branch from decision block 220, at decision block 230, the system determines what advertisement is currently being viewed and whether a corresponding extended length advertisement (ELA) exists. If it does exist, the system checks, at decision block 240, to see if the ELA is already stored on the local video storage device. If it is already stored, as depicted by the positive branch from decision block 240, the extended length advertisement is played (block 250). After it has been played, the playing time is recorded. The viewing time and an advertisement identification number are sent, at block 260, to the service provider via STB 22 over bi-directional communication link 62. The information may be sent immediately or stored and sent, with a batch of other information, at a later time (either scheduled or requested by the service provider). This information may then be used by the service provider to determine the cost to the advertiser. The system then returns to normal broadcast reception, as depicted by block 270.

If the extended length advertisement (ELA) is not available from local storage, as depicted by the negative branch from decision block 240, the set-top box may send a request to the service provider over the bi-directional communication link 62 requesting that the extended length advertisement be sent (block 280) and then return to normal broadcast reception. If the bi-directional communication link 62 has sufficient bandwidth, the advertisement may be sent in real-time, on demand; otherwise the advertisement is downloaded for later viewing.

The extended length advertisement and the current television picture may be viewed simultaneously, by showing one of them in a window or sub screen on the television display. After processing the request for an extended length advertisement the system returns to normal operation.

In a further mode of operation, the service provider may download a list of available advertisements to the set-top box at scheduled intervals. The viewer may then select advertisements to view from this list. In an exemplary embodiment, the available advertisements may be presented to the user in this list format or other graphical user interface format displayed on the television display.

In addition, the URL address of the advertiser may be linked to any advertisements from the advertiser currently stored on the local video storage device. When the user accesses the advertiser's Internet site via the set-top box, he or she will be given an option to view the stored advertisement. Again, the viewing time and the advertisement identification number are sent to the service provider over bi-directional communication link 62.

In one embodiment, the set-top box determines the identity of the current short advertisement being broadcast. This can be done by a variety of different techniques. For example, the advertisement may display a code for the viewer to enter, or a identity number might be encoded into the video data stream. The latter approach is preferred, especially for digital television broadcasts, since it requires a simpler action from the viewer. Alternatively, the service provider may monitor the television broadcast and determine the corresponding extended length advertisement from the time of the viewer input and the selected channel number. This last approach would not require the cooperation of the television broadcaster.

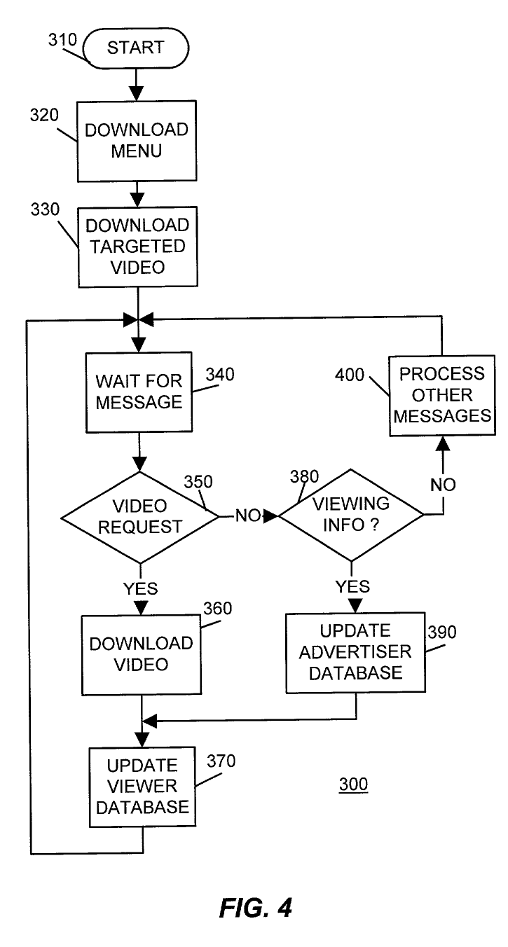

An exemplary mode of operation 300 for the media server at the service provider's head end is shown in FIG. 4. Starting at block 310, the service provider may download a list or menu of available extended length advertisements (ELAs) to the viewer's set-top box at block 320. In addition, at bock 330, the service provider may download a selection of extended length advertisements wherein the selection is determined by market research data, the viewer's prior viewing selections or the viewer's stated interests (or a combination thereof). This information is stored in a viewer database maintained by the service provider. In normal operation, the media server then waits for a message or response from the viewer at block 340. If the received response is a request for a particular extended length advertisement, as depicted by the positive branch from decision block 350, that advertisement is downloaded to the viewer's set-top box via bi-directional communication link 62 at block 360. The viewer database is then updated (block 370) to show that the viewer expressed an interest in a particular advertisement. If the received response is a request for a particular extended length advertisement, the negative branch from decision block 350 is followed. If the response is a message indicating that the viewer has viewed a particular extended length advertisement, as depicted by the positive branch from decision block 380, the advertiser database is updated at block 390 to indicate which advertiser's advertisement has been viewed and for how long. This information may then be used to determine the price to be charged to the advertiser. In addition, at block 370, the viewer database is updated to indicate that the viewer has viewed the advertisement. If the message is neither a request for an extended length advertisement nor viewing information, then it is passed to block 400 where all other messages are processed.

The bi-directional communication link 62 may also be used to exchange other information with the viewer's set-top box. For example, the service provider may provide Internet access. Other messages from the viewer can be processed in the normal way.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be stored using any suitable electronic storage medium including disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form and which can be stored in any suitable electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been particularly shown and described with reference to a preferred embodiment, it will be understood by those skilled in the art that various changes in form and detail may be made therein without departing from the spirit and scope of the invention.

What is claimed is:

1. A system for the reception and selected viewing of program information by a user, said system comprising:
a television input port operable to receive a plurality of broadcast television programs including an abbreviated program;
a user input port operable to receive signals from a user input device and including a user interface;
an input/output interface operable to transmit programs to a television for viewing; and
a processing unit operably coupled to said television input port, said user input port and said input/output interface,
wherein in response to manipulation of said user input device during the viewing of the abbreviated program received via a broadcast television channel, the processing unit will cause an extended program of the one or more extended programs that corresponds to the abbreviated program to be transmitted to said television.

2. A system as in claim 1, further comprising:
a video storage device, for storing said one or more extended programs.

3. A system as in claim 2, wherein said video storage device is a hard disc drive.

4. A system as in claim 2, wherein said video storage device is a video recorder.

5. A system as in claim 2, further comprising:
a communications port, operably coupled to said processing unit and operable to receive one or more extended programs from a remote service provider via a communications link;
wherein said remote service provider periodically transmits said one or more extended programs to said video storage device via said communications link.

6. A system as in claim 2 further comprising:
a communications port, operably coupled to said processing unit and operable to receive and request said one or more extended programs from a remote service provider;
wherein said remote service provider transmits said one or more extended programs to said video storage device in response to one or more user requests transmitted over said communications link.

7. A system as in claim 6, wherein said communications port is a digital subscriber line (DSL) modem.

8. A system as in claim 6, wherein said communications port is an optical fiber modem.

9. A system as in claim 6, wherein said one or more user requests are transmitted if said extended program is not already stored on said video storage device.

10. A system as in claim 6, further comprising:
means for recording data representing the time spent by the viewer watching each extended program of said one or more extended programs, and wherein said data is transmitted to said service provider via said communications link.

11. A system for the distribution of video programs to television viewers, said system comprising:
a first storage means for storing programs;
a communications link; and
a media server, operatively connected to said first storage means and to said communications link;
wherein in response to a request from a viewer of the television viewers, one or more extended programs are transmitted by said media server from the first storage means to the television viewer via said communications link.

12. A system as in claim 11, wherein said communications link receives data concerning the time spent by the television viewer watching said one or more extended programs.

13. A system as on claim 12, further comprising:
a second storage means for storing a viewer database of information related to the television viewer, said viewer database of information including time spent by the television viewer watching said one or more extended programs.

14. A system as in claim 11, wherein said one or more extended programs are one or more extended length advertisements provided by an advertiser to the media server.

15. A system as in claim 14, further comprising a storage means for storing an advertiser database of information related to said advertiser, said advertiser database of information including time spent by the television viewer watching the one or more extended length advertisements.

16. A system as in claim 11, wherein said communications link includes a digital subscriber line (DSL).

17. A system as in claim 11, wherein said communications link includes an optical fiber cable.

18. A method for a service provider to distribute extended programs to a television viewer, said method comprising:
providing an abbreviated program to be transmitted to the viewer via a television broadcast medium to a set-top box and displayed to the viewer on an audio visual display unit;
transmitting an extended program, corresponding to said abbreviated program, from said service provider to said set-top box via a communications link;
wherein the viewer may respond to said abbreviated program via said set-top box and request that the extended program be transmitted to said audio visual display unit for viewing.

19. A method as in claim 18, further comprising:
storing said transmitted extended program on a storage device.

20. A method as in claim 18, wherein said abbreviated program is an abbreviated advertisement and said extended program is a corresponding extended advertisement.

21. A method as in claim 20, wherein said abbreviated advertisement contains a hyperlink to said advertiser, and further comprising:
upon selection of said hyperlink by the viewer, any extended advertisements stored on the storage device and corresponding to said abbreviated advertisement are transmitted to said audio visual display unit.

22. A method as in claim 20 wherein said set-top box collects information representative of the length of time the viewer has spent viewing each extended advertisement, and further comprising:
transmitting said information from said set-top box to said service provider, thereby enabling the service provider to determine an amount to charge the advertiser.

23. A method as in claim 20, wherein the extended advertisement transmitted to the viewer is determined, in part, from market research data.

24. A method as in claim 20, wherein the extended advertisement transmitted to the viewer is determined in part from the viewer's prior viewing history.

25. A method as in claim 20, wherein the extended advertisement transmitted to the viewer is determined, in part, by one or more requests from the viewer received via said communications link.

26. A system for distributing hybrid programming to a television viewer, said system comprising:
a first transmission means for transmitting one or more abbreviated programs of said hybrid programming over a television broadcast medium;
a second transmission means for transmitting one or more extended length programs of said hybrid programming, corresponding to said one or more abbreviated programs, over a first communications link; and
a set-top box operably coupled to said television broadcast medium and to said first communications link and configured to transmit selected programs to a visual display unit for viewing by the television viewer.

27. A system as in claim 26, wherein said second transmission means transmits the one or more extended length programs in response to one or more user requests received from the television viewer via said first communications link.

28. A system as in claim 26, wherein said second transmission means transmits the one or more extended length programs in response to a scheduled program.

29. A system as in claim 26, further comprising:
data storage means operably coupled to said set-top box via a second communications link and configured to receive and store data from said set-top box relating to the viewing time by the viewer of each extended length program of the one or more extended length programs.

30. A system as in claim 29, wherein said first and second communications links are combined in a bi-directional communications link.

31. A system as in claim 26, wherein said hybrid programming comprises abbreviated advertisements and corresponding extended length advertisements.

32. A method to provide a television viewer with programming that may be selectively accessed by the viewer for extended viewing, comprising:
a service provider providing one or more abbreviated programs to a user interface;
the user interface causing the one or more abbreviated programs to be displayed on a visual display unit; and
in response to a request by the television viewer to view an extended length program, corresponding to a selected abbreviated program of the one or more abbreviated programs, displaying the extended length program on the visual display unit.

33. A method as in claim 32, wherein displaying the extended length program further comprises:
determining if said extended length program is stored locally;
if said extended length program is stored locally, transmitting said extended length program to said user interface for display on the visual display unit; and
if said extended length program is not stored locally, said service provider transmitting said extended length program to said user interface for display on said visual display unit.

34. A method as in claim 32, further comprising:
the service provider providing said user interface with a plurality of extended length programs available for display on the visual display unit; and
the user interface communicating said plurality of extended length programs to the viewer to enable the viewer to select an extended length program.

35. A method as in claim 34, wherein the user interface communicates said plurality of extended length programs to the viewer in response to a request from the viewer.

36. An electronic storage medium storing instructions which, when executed on a programmed processor, carry out a process for a service provider to distribute extended programs to a television viewer, said method comprising:
providing an abbreviated program to be transmitted to the viewer via a television broadcast medium to a set-top box and displayed to the viewer on an audio visual display unit;
transmitting an extended program, corresponding to said abbreviated program, from said service provider to said set-top box via a communications link;
wherein the viewer may respond to said abbreviated program via said set-top box and request that the extended program be transmitted to said audio visual display unit for viewing.

37. An electronic storage medium as in claim 36, further comprising:
storing said transmitted extended program on a storage device.

38. An electronic storage medium as in claim 36, wherein said abbreviated program is an abbreviated advertisement and said extended program is a corresponding extended advertisement.

39. An electronic storage medium as in claim 38, wherein said abbreviated advertisement contains a hyperlink to said advertiser, and further comprising:
upon selection of said hyperlink by the viewer, any extended advertisements stored on the storage device and corresponding to said abbreviated advertisement are transmitted to said audio visual display unit.

40. An electronic storage medium as in claim 38 wherein said set-top box collects information representative of the length of time the viewer has spent viewing each extended advertisement, and further comprising:
transmitting said information from said set-top box to said service provider, thereby enabling the service provider to determine an amount to charge the advertiser.

41. An electronic storage medium as in claim 38, wherein the extended advertisement transmitted to the viewer is determined, in part, from market research data.

42. An electronic storage medium as in claim 38, wherein the extended advertisement transmitted to the viewer is determined in part from the viewer's prior viewing history.

43. An electronic storage medium as in claim 38, wherein the extended advertisement transmitted to the viewer is determined, in part, by one or more requests from the viewer received via said communications link.
